(19) United States
(12) Patent Application Publication
(10) Pub. No.: US 2007/0051734 A1
(43) Pub. Date: Mar. 8, 2007

(54) Thermally insulated container

(75) Inventor: Joachim Kuhn, Würzburg (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: VA-Q-TEC AG, Wurzburg (DE)

(21) Appl. No.: 10/557,398

(22) PCT Filed: May 5, 2004
(86) PCT No.: PCT/DE04/00953

§ 371 Date: Aug. 11, 2006

(30) Foreign Application Priority Data
May 19, 2003 (DE) 103 22 764.4

(51) Int. Cl. A47J 41/00

(52) U.S. Cl. 220/592.27

(57) ABSTRACT

The invention relates to a thermally insulated container (01), in particular for shipping purposes, having a container wall (02) which completely encloses an interior space (07), wherein the interior space (07) has at least one closable opening and is insulated with at least one vacuum insulation element (24) to prevent heat exchange. At least one passive melt-storage element (16, 17) that is filled with a melt-storage material is provided in the container (01).

The invention relates to a thermally insulated container according to the preamble of claim 1.

Such thermally insulated containers are used in particular but by no means exclusively for shipping purposes, to be able to ship temperature-sensitive goods such as medications while maintaining narrow temperature tolerances. With generic containers, a container wall is provided, completely surrounding an interior space in which the goods to be shipped are arranged. At least one closable opening is provided in the container wall to be able to introduce the goods to be shipped into the container.

To minimize the heat flow through the container wall as much as possible, vacuum insulation elements are used for insulation. These vacuum insulation elements have a very high heat transport resistance with a relatively low layer thickness, so that with a given exterior volume, a relatively large useful volume is achieved with adequate thermal insulation. Due to the vacuum insulation elements, the heat flow from the outside to the inside as well as from the inside to the outside is impeded, so the goods to be shipped are protected against excessive heat as well as against excessive cold.

Thermally insulated containers are known from the state of the art. With these containers, active cooling systems are used for additional cooling. For example, it is known that the interior of the container is heated by means of an electric climatization system. Systems in which dry ice is evaporated and the resulting cold vapor is used to cool the interior space are also known. These actively cooled containers have the disadvantage that they are extremely sensitive to interference. For example, if the electric climatization system or fan in the dry ice system does not receive adequate electric power, adequate cooling is no longer ensured and the goods shipped will spoil.

On the basis of this state of the art, the object of the present invention is therefore to propose a novel thermally insulated container.

This object is achieved by a container according to the teaching of claim 1.

Advantageous embodiments of this invention are the object of the subclaims.

The invention is based on the basic idea of providing in the container passive melt-storage elements that are filled with a suitable melt-storage material. Such melt-storage elements have the property of being able to store and/or release a certain quantity of heat through phase transition of the melt-storage material. In other words, this means that the melt-storage material in the melt-storage element will melt on heating until the entire supply of melt-storage material has entered the liquid phase. The thermal energy required for phase transition of the melt-storage material is therefore stored in the melt-storage material and does not result in an increase in temperature. Conversely, if the melt-storage material is cooled, the melt-storage material will gradually solidify, releasing the stored thermal energy in this phase transition. As a result, the melt-storage elements thus buffer the heat flow until reaching the limits of their capacity, in accordance with their respective capacity.

Depending on the melting point of the melt-storage material, there are other buffering areas for buffering the heat flow. If the melt-storage material contains paraffin, for example, then heat flow buffering in the temperature range above 0° C. is possible. However, if the melt-storage material contains a salt solution, for example, the heat flow may be buffered in the temperature range below 0° C.

Since each melt-storage material has an optimum buffering range, depending on its respective melting point, it is especially advantageous for certain applications if at least two different melt-storage elements are provided in the container, each element being filled with different melt-storage materials. Through this combination of different melt-storage materials in one container, the buffering range can be spread. It is especially advantageous if the melt-storage elements filled with different melt-storage materials are arranged in multiple layers in the container.

To be able to check on whether or not the melt-storage elements are ready to be used, e.g., after loading a container, it is advantageous if temperature measurement devices are provided on the melt-storage elements so that the temperature of the melt-storage elements can be measured. To do so, known temperature sensors using displays which change colors as a function of temperature may be used, for example.

The construction of the vacuum insulation elements is essentially irrelevant. According to a preferred embodiment, a base body surrounded by a film in an airtight seal is used for this purpose. The interior space formed by the film is evacuated to be able to achieve the desired insulation properties. The base body itself provides the required mechanical stability for the vacuum insulation element, and open-pored materials should be used to manufacture the base body to ensure adequate evacuability.

If film-sheathed vacuum insulation elements are used, they should preferably not have any protruding edge strips of film so that the butt joint between adjacent vacuum insulation elements can be designed to be as narrow as possible.

The insulating effect of the vacuum insulation elements depends to a significant extent on having a sufficiently low internal gas pressure prevailing in the vacuum insulation element. The greater the increase in the internal gas pressure in the vacuum insulation element, the greater the heat transfer through the vacuum insulation element. To be able to test the functionality of the vacuum insulation elements at any time, even after installing them in the container, the vacuum insulation elements should have a monitoring system for monitoring the internal gas pressure. To this end, metal chips, for example, may be arranged beneath the enveloping film, in which case the internal gas pressure can then be derived by using suitable diagnostic devices in the area of the metal chips by applying a jump in temperature.

If the vacuum insulation elements are installed behind the container wall, e.g., when using a double wall container, the container wall should have revision openings through which the monitoring system is accessible for monitoring the internal gas pressure. In this way, the functionality of the installed vacuum insulation elements can be tested at any time, in particular before loading again to avoid damage to the goods to be shipped due to inadequate insulation, such as that which may be caused by micro-leaks in the vacuum insulation elements, for example.

To rule out the possibility of damage to the vacuum insulation elements due to penetration of foreign bodies, covers may be provided, preferably transparent, on the revision openings so that the monitoring system behind the cover is discernible from the outside.

To increase the heat flow resistance, the vacuum insulation elements may also be arranged in several layers one above the other or behind the other. The resulting heat flow resistance is obtained essentially by adding the heat flow resistance of the individual layers.

According to a first embodiment of the present invention, the container may be designed in the manner of a shipping container. If this shipping container is also approved for air freight, then temperature-sensitive products such as medications, e.g., vaccines in particular, can be shipped over great distances and long shipping times within the specified temperature tolerances.

As an alternative to that, the container may also be designed in the manner of a shipping box with a removable cover. Such shipping boxes are advantageous in particular when return shipping of the container is not intended and instead the container is to be disposed of after reaching its destination.

In order to reduce the cost of the shipping box, it is conceivable to insulate only partial areas of the container wall of the shipping box, in particular the cover and bottom of the shipping box, with at least one vacuum insulation element each because the cover and bottom allow relatively large quantities of heat to flow through because of their large area, whereas other parts of the container wall are of subordinate importance.

To manufacture the container wall of the shipping box, foamed plastics are suitable in particular because this material itself has a high heat flow resistance and is also available very inexpensively.

By installing multiple vacuum insulation elements in various container walls, an improved damage redundancy is achieved because the insulation properties of the container are influenced only to a relatively minor extent when there is damage to an individual vacuum insulation element. One embodiment of the present invention is illustrated schematically in the drawings and is explained in greater detail below as an example.

The drawings show:

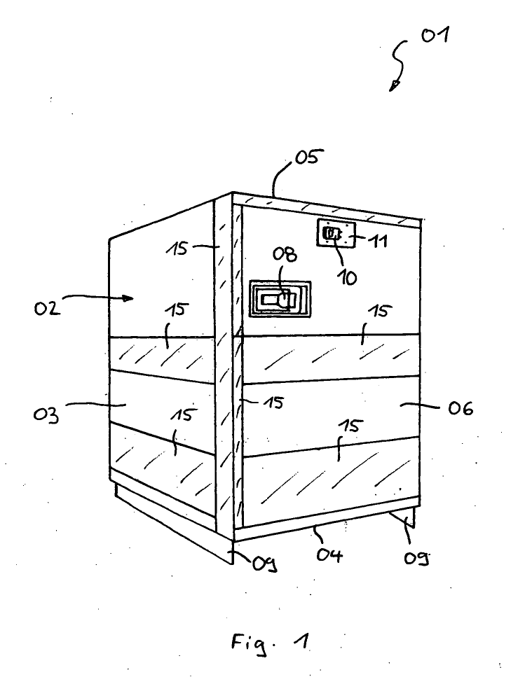

FIG. 1 a shipping container in a perspective view from the outside;

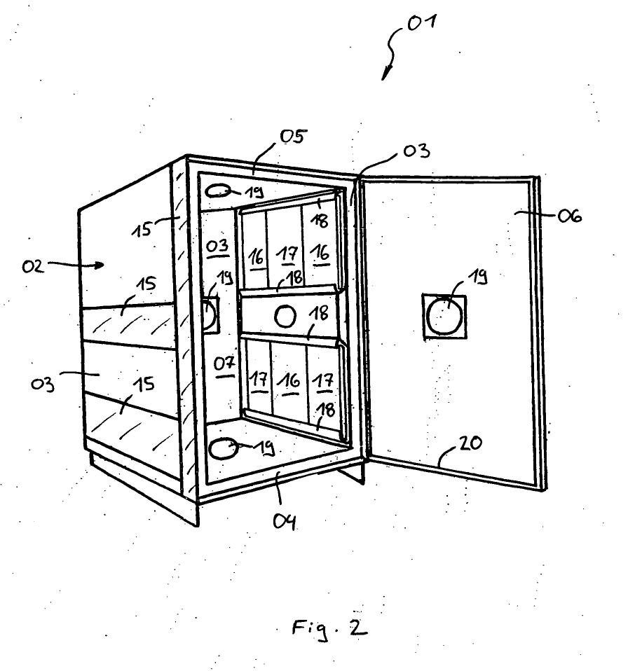

FIG. 2 the shipping container according to FIG. 1 with the door opened, in a perspective view;

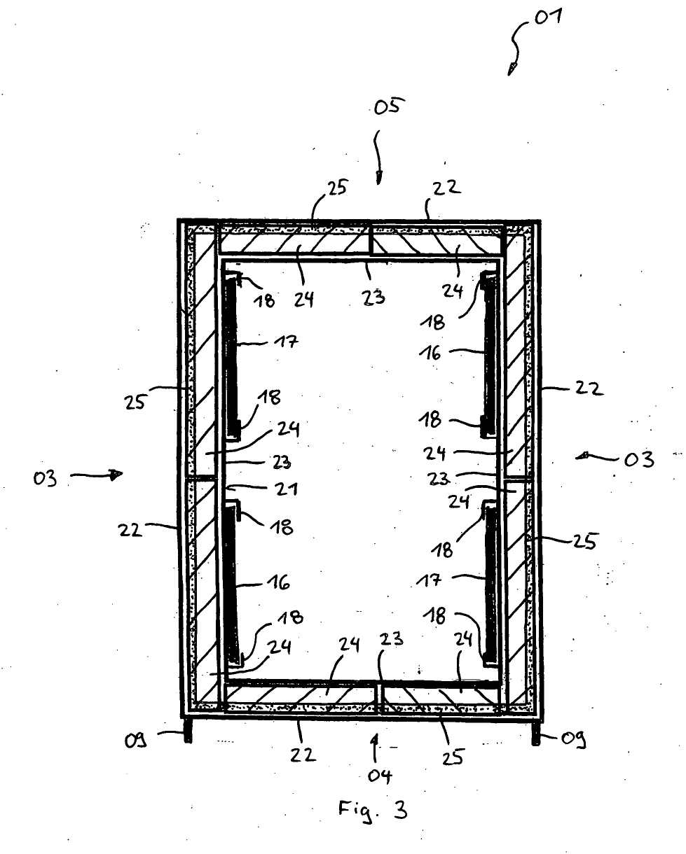

FIG. 3 the shipping container according to FIG. 1 in cross section;

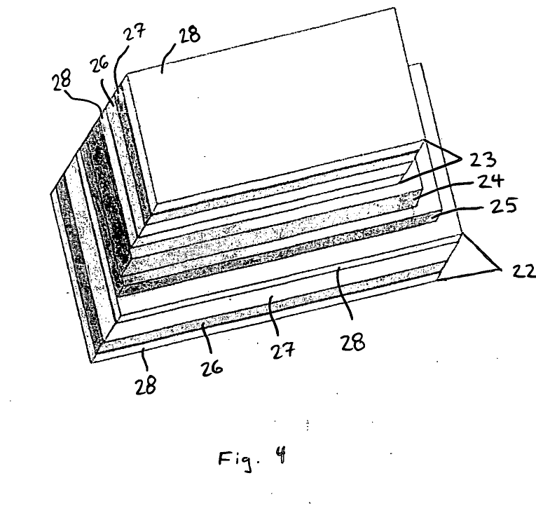

FIG. 4 the container wall of the shipping container according to FIG. 1 in a perspective sectional view;

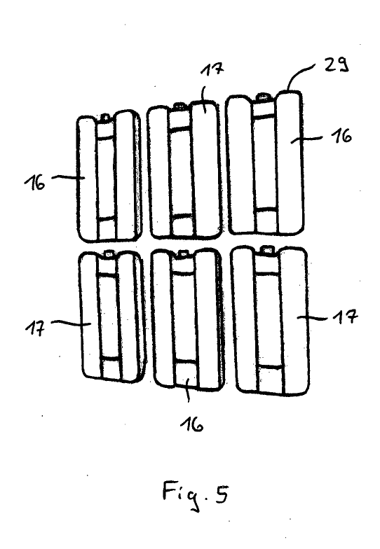

FIG. 5 the melt-storage elements of the shipping container according to FIG. 1 in a perspective view;

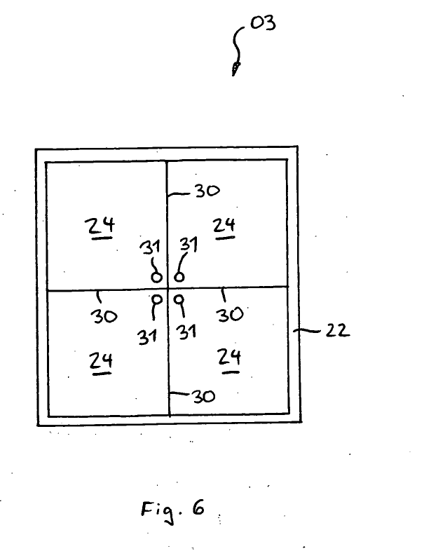

FIG. 6 the arrangement of the vacuum insulation elements on a side wall of the shipping container according to FIG. 1 in a side view;

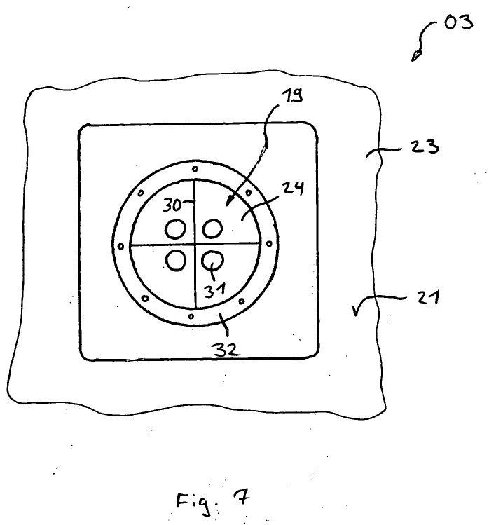

FIG. 7 a revision opening in a container wall of the shipping container according to FIG. 1;

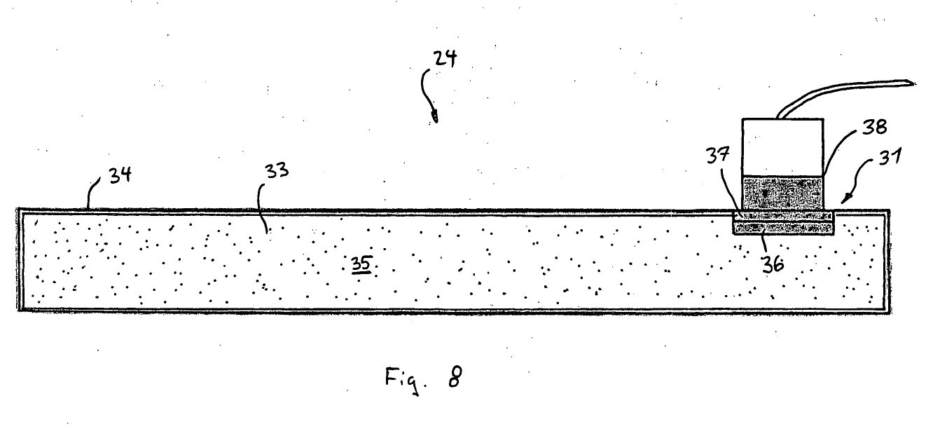

FIG. 8 a vacuum insulation element of the shipping container according to FIG. 1 in cross section;

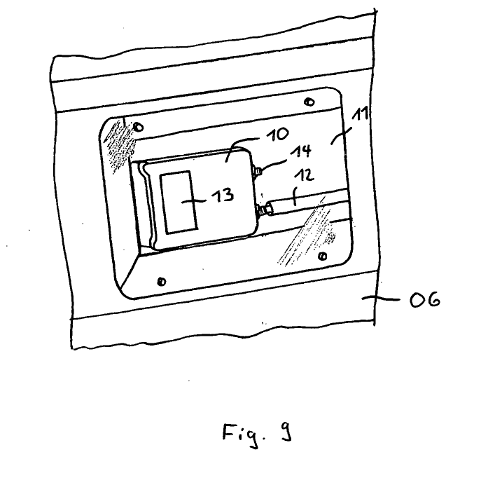

FIG. 9 the data memory on the shipping container according to FIG. 1 in an enlarged perspective view;

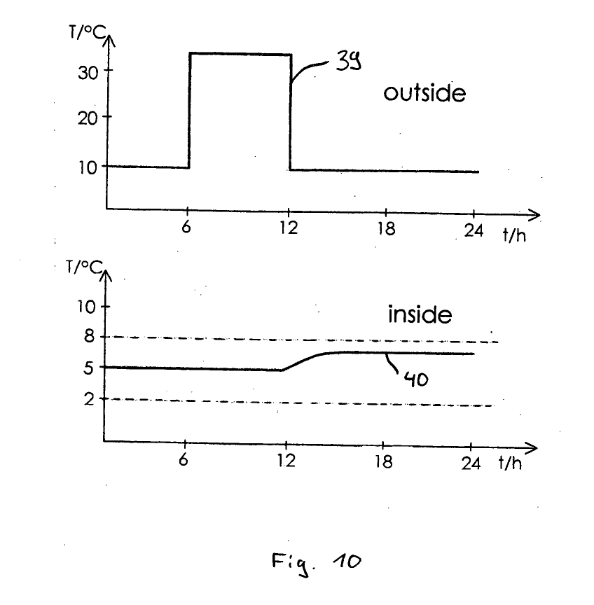

FIG. 10 the inside temperature curve in the interior of the shipping container according to FIG. 1 when a positive outside temperature jump is applied;

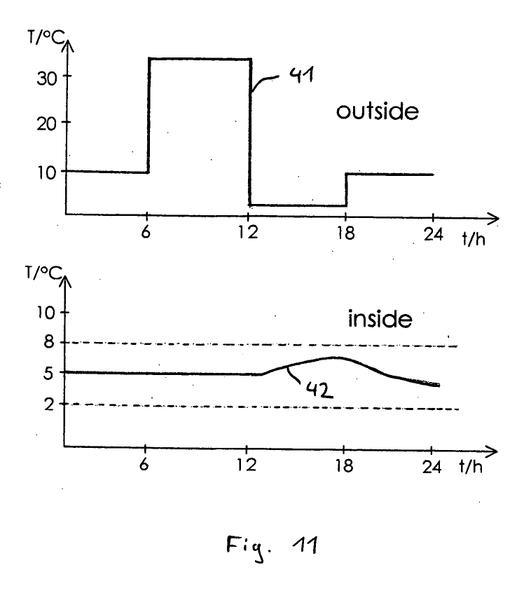

FIG. 11 the inside temperature curve in the interior of the shipping container according to FIG. 1 when a positive outside temperature jump and a negative outside temperature jump are applied;

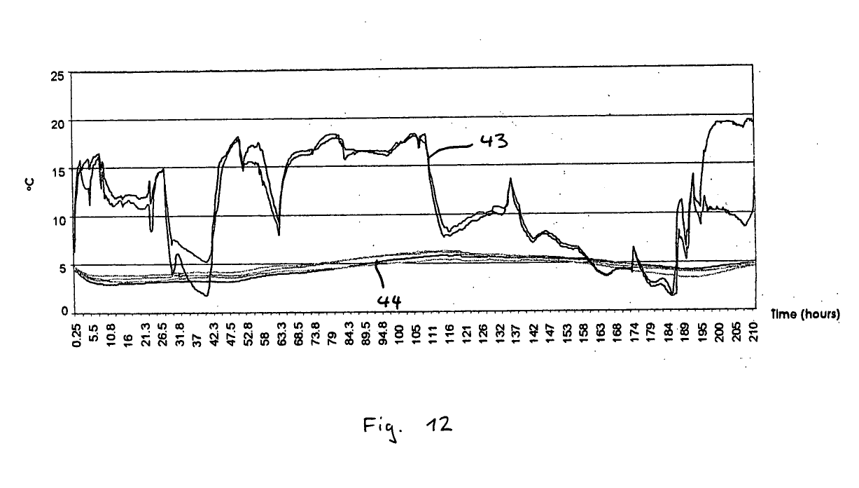

FIG. 12 the inside temperature curve in the interior of the shipping container according to FIG. 1 in passing through an outside temperature profile.

FIG. 1 shows a container 01 designed in the manner of a shipping container, shown here in a perspective view. Heat-sensitive goods such as medications, vaccines in particular, can be shipped over a great distance and by air freight when shipped in the container 01. The base area of the container 01 corresponds to the area of a standard pallet.

The container wall 02 of the container 01 consists of three rectangular side wall elements 03, a rectangular bottom element 04, a rectangular cover element 05 and a pivotably mounted door element 06. The three side wall elements 03, the bottom element 04 and the cover element 05 are fixedly joined together, forming a cubical interior space 07. After closing the door element 06, the interior space 07 is surrounded on all sides and is insulated from the flow of heat through the container wall 02 by vacuum insulation elements which are described in greater detail below.

A locking element 08 is used to lock the door element 06; when this locking element 08 is operated, lock bar elements (not shown in FIG. 1) can be locked or unlocked. A seal may be applied to the locking element 08 in order to secure the container 01 against unauthorized opening. As an alternative and/or in addition to that, a lock, e.g., a cylinder lock or a numerical lock may also be provided on the locking element 08 to prevent unauthorized opening of the container 01.

Two strips 09 are mounted on the underside of the bottom element 04, forming an interspace between the bottom element 04 and the standing surface. The arms of a forklift can be inserted into this interspace to allow the container 01 to be raised and transported using a forklift. At the top side of the door element 06 a data memory device 10 is mounted in a recess and is protected from the outside by a cover 11 (see also FIG. 9). To protect the container wall 02 from the penetration of pointed objects, protective panels 15 may be mounted in areas on the outside that are at particular risk. The protective panels 15 may be made of sheet metal, for example.

FIG. 2 shows the interior structure of the container 01. Six melt-storage elements 16 and 17 are arranged on the inside of the two lateral side walls 03. The melt-storage elements 16 are filled with a paraffin-based melt-storage material, whereas the melt-storage elements 17 contain a salt solution. Fastening rails 18 (see also FIG. 3) are used, extending around the melt-storage elements 16 and 17 at both the upper and lower edges in a form-fitting manner. In this way the melt-storage elements 16 and 17 can be replaced easily by inserting them from the door side into the fastening rails 18. After closing the door element 06, the melt-storage elements 16 and 17 are attached to the inside of the container wall 02. This type of fastening makes it possible in particular to install and dismantle the melt-storage elements 16 and 17 without requiring tools.

Revision openings 19, the function of which is explained in greater detail below, are provided in the three side wall elements 03, the bottom element 04, the cover element 05 and the door element 06.

A sealing lip 20 is provided on the inside of the outside circumference of the door element 06, sealing the joint between the door element 06 on the one hand and the edge of the two opposing side wall elements 03 and/or the edge of the cover element 05 and the bottom element 04 after the door element 06 is closed.

FIG. 3 shows the container 01 in cross section from the front schematically. The melt-storage elements 16 and 17 are flat, i.e., like panels, and are arranged in parallel with the container wall 02 on the inside 21 of the container 01. The container wall 02 itself is constructed as a double wall from a dimensionally stable outside wall 22 and an inside wall 23, also dimensionally stable. The vacuum insulation elements 24 which are provided for insulation are arranged between this mechanically stable double wall consisting of outside wall 22 and inside wall 23. Impact prevention elements 25 made of foamed plastic are provided between the vacuum insulation elements 24 and the outside wall 22. The size ratios between the outside wall 22, the inside wall 23, the vacuum insulation elements 24 and the impact prevention elements 25 are indicated only schematically in FIG. 3. The exact structure of the design of the container wall 02 is shown in FIG. 4.

The perspective cross section through the container wall 02 shown in FIG. 4 illustrates that the outside wall 22 and the inside wall 23 are each made of a sandwich material. In this sandwich material an inner core layer 26 of plywood and an inner core layer 27 of foamed plastic are each covered on the outside by cover layers 28 of fiber-reinforced plastic.

FIG. 5 shows a possible embodiment of dimensionally stable melt-storage containers 29. By filling the containers 29 with a suitable melt-storage material, the various types of melt-storage elements 16 and 17 can be produced.

FIG. 6 shows the arrangement of the vacuum insulation panels 24 in a side wall 03 as an example. Each of four vacuum insulation elements 24 is arranged adjacent to one another in all side wall elements 03 and accordingly also in the bottom element 04, in the cover element 05 and in the door element 06. This ensures that in the event of damage to one vacuum insulation element, e.g., caused by a micro-leak, there will not be a failure of the entirety of the insulation in the respective container wall. Instead, there is still sufficient insulation of the container 01 on the whole even in the event of failure of an individual vacuum insulation element. The flat vacuum insulation elements 24 designed in the manner of thermal insulation panels come in contact at butt joints 30. In order for the least possible amount of heat to be transmitted into the butt joints 30, an insulation material may be provided in the butt joints 30. In addition, the vacuum insulation elements 24 should, if possible, not have any protruding film straps so that the vacuum insulation elements 24 can be installed in the butt joints 30 in close proximity as much as possible. To increase the heat flow resistance, another layer of vacuum insulation elements may also be provided in the container wall 02, and if multiple layers are used, the butt joints 30 should be offset with respect to one another if possible.

A monitoring system 31 for monitoring the internal gas pressure is provided on each vacuum insulation element 24. The four monitoring systems 31 of the four vacuum insulation elements 24 are arranged adjacent to one another at the center of the container wall so that the four different monitoring systems 31 are accessible through a single revision opening 19.

FIG. 7 shows the revision opening 19 with the four monitoring systems 31 arranged behind a cover 32, shown on an enlarged scale. To monitor the internal gas pressure in the vacuum insulation elements 24, the cover 32 is removed and a test head of a diagnostic apparatus is placed on the monitoring systems 31. The design and functioning of the monitoring system 31 and the structure of the vacuum insulation elements 24 are shown in FIG. 8.

The cross section through the vacuum insulation elements 24 shown in FIG. 8 shows an open-pored base body 33 wrapped with a film 34 in an airtight manner. The airtight interior 35 formed by the film 34 is evacuated to impart the desired insulation properties to the vacuum insulation element 24. To test the internal gas pressure in the interior 35 of the vacuum insulation element 24, the monitoring system 31 consisting of a metal chip 36 and an intermediate layer 37 is placed on the inside of the film 34. Using a test head 38, a defined temperature jump can then be applied to the monitoring system 31, in which case the internal gas pressure in the interior 35 can be derived from the signal response to the temperature jump.

As FIG. 9 shows, the data memory device 10 is connected by a cable 12 to an internal temperature sensor for measuring the temperature in the interior space 07 and to an outside temperature sensor for measuring the ambient temperature surrounding the container 01. At regular intervals, the inside temperature and the outside temperature are measured and the resulting measurement data is stored in the data memory device 10 for documentation purposes. The current inside temperature and/or the current outside temperature can be displayed on a display 13 and read through the transparent cover 11 from the outside. A GPS receiver (not shown) may be connected to the data memory device 10 via a terminal 14 so that the position data of the container 01 can be stored by the data memory device 10 for documentation purposes.

The function of the container 01 for temperature insulation will now be explained as an example on the basis of the temperature curves shown in FIGS. 10 through 12.

FIG. 10 shows a schematic diagram of a situation in which the container 01 is exposed to an outside temperature profile 39. The resulting change in the inside temperature in the interior space 07 of the container 01 is plotted with the inside temperature profile 40. The outside temperature profile 39 includes a temperature jump of 10° C. to 30° C. over a period of 6 hours. This change in the outside temperature at first does not result in any temperature change in the interior space 07 because the quantities of heat allowed to pass through the vacuum insulation elements 24 are buffered by the melt-storage elements 16 and 17 through phase transition of the melt-storage material. Only after a time lag, when large quantities of the melt-storage material have already undergone a phase transition does the inside temperature in the interior space 07 increase very slowly.

FIG. 11 shows a second outside temperature profile 41 and the resulting inside temperature profile 42 in the interior space 07 of the container 01. The outside temperature profile 41 passes through a negative temperature jump to just above 0° C. immediately after the positive temperature jump to 30° C. The negative temperature jump also lasts for 6 hours. The negative temperature jump is also buffered by the melt-storage elements 16 and 17, whereby the melt-storage elements are again regenerated by the reduction in temperature so that a subsequent positive temperature jump can again be buffered easily.

FIG. 12 shows an actual outside temperature profile 43 and a resulting inside temperature profile 44, recorded in a long-term test for 210 hours. The different curves for the outside temperature profile 43 and the inside temperature profile 44 correspond to the different measurement points outside and inside the container 01. As shown directly from FIG. 11, the inside temperature remains within a narrow temperature band, despite the considerable fluctuations in the outside temperature, so that temperature-sensitive products are effectively protected from excessive temperature fluctuations in the interior space 07 of the container.

1. A thermally insulated container (01), especially for shipping purposes, having a container wall (02) that completely encloses an interior space (07), whereby the interior space (07) has at least one closable opening and is insulated to prevent heat exchange with at least one vacuum insulation element (24),
characterized in that
at least one passive melt-storage element (16, 17) filled with a melt-storage material is provided in the container (01).

2. The container according to claim 1,
characterized in that
the melt-storage element is designed in the manner of a melt-storage container (29) having a dimensionally stable container wall that surrounds the melt-storage material in a fluid-tight manner.

3. The container according to claim 2,
characterized in that
the melt-storage containers (29) have a flat shape and can be arranged parallel to the container wall (02) in the container (01).

4. The container according to any one of claims 1 through 3,
characterized in that
the melt-storage material contains paraffin.

5. The container according to any one of claims 1 through 3,
characterized in that
the melt-storage material contains a salt solution.

6. The container according to any one of claims 1 through 5,
characterized in that
at least two different melt-storage elements (16, 17) are provided in the container (01), each being filled with different melt-storage materials.

7. The container according to claim 6,
characterized in that
the different melt-storage materials in the different melt-storage elements (16, 17) each have a different melting point.

8. The container according to any one of claims 1 through 7,
characterized in that
multiple melt-storage elements are arranged in multiple layers in the container, the melt-storage elements of the different layers being filled in particular with different melt-storage materials.

9. The container according to any one of claims 1 through 8,
characterized in that
the melt-storage elements (16, 17) can be detachably secured in the container in particular without using a tool.

10. The container according to claim 9,
characterized in that
at least one fastening rail (18) that reaches around the edge of the melt-storage elements (16, 17) in a form-fitting manner is provided for fastening the melt-storage elements (16, 17) in the container (01).

11. The container according to any one of claims 1 through 10,
characterized in that
a temperature measuring device, in particular a temperature sensor which changes colors as a function of temperature, is provided on at least one melt-storage element (16, 17); the temperature of the melt-storage element (16, 17) can be measured with this sensor.

12. The container according to any one of claims 1 through 11,
characterized in that
the vacuum insulation element (24) has a base body (33) which is made in particular of microporous silica, fiber material, microfiber material or open-pored polymer foam, and which is surrounded by a film (34) in an airtight manner, and the interior space (35) thereby formed by the film (34) is evacuated.

13. The container according to claim 12,
characterized in that
the film (34) of the vacuum insulation element (24) does not have any protruding edge straps.

14. The container according to any one of claims 1 through 13,
characterized in that
the vacuum insulation element (24) has a layer thickness of 5 mm to 100 mm.

15. The container according to any one of claims 1 through 14,
characterized in that
the vacuum insulation element (24) has an internal or external monitoring system (31) for monitoring the inside gas pressure in the vacuum insulation element (24).

16. The container according to claim 15,
characterized in that
at least one revision opening (19) is provided in the container wall (02), the monitoring system (31) for monitoring the inside gas pressure in the vacuum insulation element (24) being accessible through this opening.

17. The container according to claim 16,
characterized in that
the revision opening (19) can be closed with a cover (32), in particular a transparent cover.

18. The container according to any one of claims 1 through 17,
characterized in that
the vacuum insulation elements (24) have a flat shape, and are designed in particular in the manner of thermal insulation sheets.

19. The container according to any one of claims 1 through 18,
characterized in that
the container wall (02) is formed by multiple wall elements (03, 04, 05, 06), in particular rectangular and flat wall elements, and in particular three side wall elements (03), a cover element (05), a bottom element (04) and a door element (06) are provided.

20. The container according to claim 19,
characterized in that
multiple vacuum insulation elements (24) for insulation are provided in each individual wall element (03, 04, 05, 06).

21. The container according to claim 20,
characterized in that
at least two, in particular at least four vacuum insulation elements (24) are arranged side-by-side in the wall elements (03, 04, 05, 06), with neighboring vacuum insulation elements (24) contacting one another in a butt joint (30).

22. The container according to claim 21,
characterized in that
a thermally insulating insulation material is provided in the butt joint (30).

23. The container according to any one of claims 20 through 22,
characterized in that
the vacuum insulation elements are arranged one above the other in at least two layers.

24. The container according to claim 23,
characterized in that
the butt joints are offset with respect to one another in different layers between adjacent vacuum insulation elements.

25. The container according to any one of claims 1 through 24,
characterized in that
an insulation body is formed by multiple vacuum insulation elements (24), surrounding the interior volume (07) on all sides.

26. The container according to any one of claims 1 through 25,
characterized in that
the container wall is made of wooden panels and/or plastic panels and/or laminated metal panels.

27. The container according to any one of claims 1 through 26,
characterized in that
the container wall (02) is designed as a double wall with an outside wall (22) and an inside wall (23).

28. The container according to claim 27,
characterized in that
the outside wall (22) and the inside wall (23) are each mechanically stable and are designed to be self-supporting.

29. The container according to claim 28,
characterized in that
the outside wall (22) and/or the inside wall (23) is/are manufactured from a lightweight construction material, in particular a sandwich material having multiple layers of material (26, 27, 28).

30. The container according to claim 29,
characterized in that
the sandwich material has a first outer cover layer (28) of fiber-reinforced plastic and/or an inner core layer (26) of plywood and/or an inner core layer (27) of foamed plastic, in particular foamed polyurethane plastic and/or a second outer cover layer (28) of fiber-reinforced plastic.

31. The container according to any one of claims 27 through 30,
characterized in that
the vacuum insulation elements (24) are arranged between the outside wall (22) and the inside wall (23).

32. The container according to claim 31,
characterized in that
impact protection elements (25), in particular impact protection elements (25) made of foamed plastic, are arranged between the vacuum insulation elements (24) on the one hand and the outside wall (22) and/or inside wall (23) on the other hand.

33. The container according to any one of claims 27 through 32,
characterized in that
the melt-storage elements (16, 17) are arranged on the inside (21) of the inside wall (23) of the double-walled container wall (02).

34. The container according to any one of claims 1 through 33,
characterized in that
the container (01) is designed as a shipping container suitable for air freight in particular.

35. The container according to claim 34,
characterized in that
a container wall (02) or a part of a container wall is designed in the manner of a movably supported door (06) for closing the opening in the interior space (07) of the shipping container (01), whereby the door is mounted to be pivotable about a vertical axis in particular.

36. The container according to claim 34 or 35,
characterized in that
all the wall elements (03, 04, 05, 06) of the shipping container are insulated with at least one vacuum insulation element (24) each.

37. The container according to any one of claims 34 through 36,
characterized in that
a sealing element (20), in particular a double sealing lip, is provided in the joint between the door (06) and the opening in the shipping container (01).

38. The container according to any one of claims 34 through 37,
characterized in that
the vacuum insulation elements are arranged in the area of the opening in the shipping container such that the vacuum insulation elements overlap at least slightly in the area of the joint after closing the door.

39. The container according to claim 38,
characterized in that
the width of the overlap corresponds to at least half the thickness of the vacuum insulation elements.

40. The container according to any one of claims 34 through 39,
characterized in that
the door (06) of the shipping container (01) can be locked with a locking element (08).

41. The container according to claim 40,
characterized in that
a seal can be applied to the locking element (08).

42. The container according to claim 40 or 41,
characterized in that
a lock is provided on the locking element (08) for locking the shipping container (01).

43. The container according to any one of claims 34 through 42,
characterized in that
the shipping container (01) has function elements (09) for engaging in the arms of forklifts.

44. The container according to any one of claims 34 through 43,
characterized in that
at least one temperature sensor is provided on the shipping container (01) with which the outside temperature and/or the inside temperature can be measured.

45. The container according to any one of claims 34 through 44,
characterized in that
a position sensor, in particular a GPS receiver, is provided on the shipping container (01) so that the position of the container can be ascertained.

46. The container according to claim 44 or 45,
characterized in that
a data memory device (10) is provided on the shipping container (01) with which measurement results of the temperature sensor and/or the GPS receiver can be stored.

47. The container according to any one of claims 1 through 33,
characterized in that
the container is designed in the manner of a shipping box, in particular in the shape of a trough having a removable cover for closing the opening to the interior space.

48. The container according to claim 47,
characterized in that
only partial areas of the container wall of the shipping box, in particular only the top and bottom of the shipping box, are insulated with one vacuum insulation element each.

49. The container according to claim 47 or 48,
characterized in that
the container wall of the shipping box is manufactured from a foamed plastic.

50. The container according to any one of claims 1 through 49,
characterized in that
the container is provided for shipping pharmaceutical and/or biotechnological products, in particular vaccines or paints or varnishes.

51. The container according to any one of claims 1 through 50,
characterized in that
a supporting frame, in particular made of metal sections, is provided on the container for mechanical support of the container wall.
